(19) United States
(12) Patent Application Publication
(10) Pub. No.: US 2022/0185577 A1
(43) Pub. Date: Jun. 16, 2022

(54) Brew Bag of Drink Mix

(71) Applicants: Jerry Darsey, Little Rock, AR (US); Sylvia Szwedo, Lublin (PL); Nouf Masarweh, Virginia Beach, VA (US)

(72) Inventors: Jerry Darsey, Little Rock, AR (US); Sylvia Szwedo, Lublin (PL); Nouf Masarweh, Virginia Beach, VA (US)

(21) Appl. No.: 17/552,713

(22) Filed: Dec. 16, 2021

Related U.S. Application Data
(60) Provisional application No. 63/126,057, filed on Dec. 16, 2020.

(51) Int. Cl. B65D 85/808; A23F 5/40; A23F 3/30

(52) U.S. Cl. CPC B65D 85/808; A23F 3/30; A23F 5/40

(57) ABSTRACT

A travel-ready brew bag of drink mix that includes a primary ingredient and at least one enhancement ingredient. The primary ingredient includes coffee or tea. The enhancement ingredients include creamer, sugar, artificial sweeteners, honey, vanilla, caramel flavoring, and peppermint flavoring.

### CROSS-REFERENCE TO RELATED APPLICATIONS

This application claims the benefit of U.S. Provisional Application No. 63/126,057, entitled “Coffee on the Go: My Perfect Cup of Coffee” and filed on Dec. 16, 2020. The complete disclosure of said patent application is hereby incorporated by reference.

### STATEMENT REGARDING FEDERALLY SPONSORED RESEARCH OR DEVELOPMENT

Not applicable

### BACKGROUND OF THE INVENTION

According to some studies U.S. Americans consume 400 million cups of coffee per day, making the United States the leading consumer of coffee in the world. Other studies suggest that approximately 64% of U.S. American adults consume coffee every single day, with the average U.S. American drinking 3.1 cups of coffee per day. And while some studies show that nearly 79% of coffee drinkers prepare and drink their coffee at home, in one study, nearly 40% of respondents said that they had a cup of coffee away from home the day before. And that trend is rising: in 2019, Starbucks had 31,256 stores across the globe, compared to only 29,324 stores worldwide in 2018, and records show that Starbucks's year-over-year- growth almost doubled in the last decade.

And it's not just the need for caffeine that is leading to increased coffee drinking and increased to-go coffee drinking. It's also about convenience. For example, only a few years ago, coffee drinkers who wanted to enjoy a cup of coffee had to brew whole pots of coffee, even if only a single cup was needed. Now, there are coffee brewing machines that allow consumers to brew a single cup of coffee using only a cup of water and a coffee pod. These machines, however, can be pricey and still are too large for quick and easy travel, meaning that the coffee must still be made prior to leaving the home. While coffee made at home can be kept warm for later enjoyment using a thermos or other specialized mug, there is nothing that can beat a fresh, hot cup of coffee.

It would therefore be desirable to develop a convenient, travel-ready coffee product that allows the user to easily prepare a single cup of perfect coffee even when there is no coffee pot or other specialized equipment nearby. What is needed is a product that can transform an ordinary cup of hot water into a fresh, ready-to-drink cup of coffee.

### BRIEF SUMMARY OF THE INVENTION

The present invention is directed to a travel-ready brew bag of drink mix that includes a primary ingredient and at least one enhancement ingredient. The primary ingredient includes coffee or tea. The enhancement ingredients include creamer, sugar, artificial sweeteners, honey, vanilla, caramel flavoring, and peppermint flavoring.

These and other features, objects and advantages of the present invention will become better understood from a consideration of the following detailed description of the preferred embodiments and appended claims in conjunction with the drawings as described following:

### BRIEF DESCRIPTION OF THE DRAWINGS

FIG. 1 is a schematic of a brew bag with drink mix of the present invention in a cup of water with steam rising from the cup.

### DETAILED DESCRIPTION OF THE INVENTION

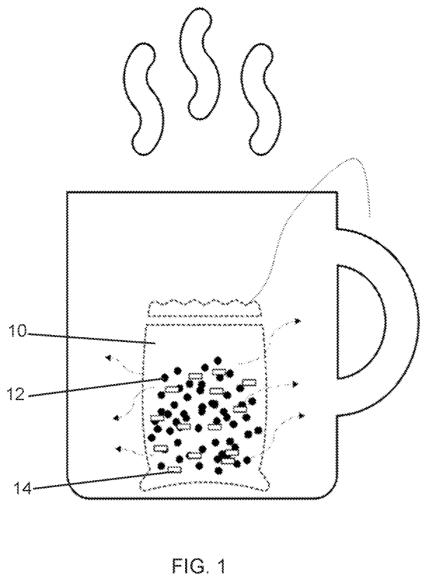

With reference to FIG. 1, the preferred embodiments of the present invention may be described. The present invention is directed to a travel-ready brew bag of drink mix. In one embodiment, the drink mix may be a pre-mixed coffee product that is ready to be transformed into a hot cup of coffee merely by adding the product to a cup of hot water. The invention requires no specialized brewing equipment, pots, or kitchen appliances, and can be easily modified to suit the needs, tastes, and preferences of many different coffee drinkers.

Generally speaking, the present invention is directed to a pre-mixed, ready to brew bag 10 of drink mix comprising a primary ingredient 12 (e.g., coffee or tea) and at least one enhancement ingredient 14, as shown in FIG. 1. While the invention is described with reference to a coffee product, it is understood that the product may not be so limited. Other hot drinking products, like tea for example, may also be used instead of coffee.

In the preferred embodiment, the invention is directed to a pre-mixed, ready to brew bag of coffee. Inside the bag is a mixture of various ingredients suitable to make the coffee or other drink. For example, in the preferred embodiment, the bag stores ready-to-brew coffee in addition to enhancement ingredients. The coffee is preferably fresh ground coffee but may alternatively be dehydrated coffee, although the flavor is not as fresh when dehydrated coffee granules are used. The enhancement ingredients may be a number of other ingredients that enhance the flavor or other characteristics of the coffee. Suitable and common enhancement ingredients include, but are not limited to, creamer, sugar, artificial sweeteners, honey (such as powdered honey or dehydrated honey), and other similar products. Other enhancement ingredients include flavor granules or flavoring to provide the coffee with some specific flavoring, such as vanilla, caramel flavoring, peppermint flavoring, etc. While the ingredients in the bag are preferably solid, dry, non-perishable ingredients, it is understood that any type of ingredients desirable for providing or enhancing the flavor the drink may be included.

As noted, the primary ingredient and enhancement ingredients are stored in a ready-to-brew bag or container 10. In the preferred embodiment, the bag may be a single-use, disposable bag or other container. The bag or container is preferably a porous bag, such that when the bag is immersed in hot water in a cup, the flavors of the ingredients are infused into the water, as shown in FIG. 1. In this regard, the material of the bag may be similar to that of a coffee filter used when making coffee using a coffee pot or other appliance. The bag may be pre-sealed during manufacturing such that the internal ingredients are not modifiable by the consumer. In another embodiment, the bag is manufactured such that the consumer can modify the internal ingredients by opening the bag after loosening or removing the string tied around the crimped top of the bag, as shown in FIG. 1. In one embodiment, it may be seen that the bag is made of a recyclable or compostable material so that disposal of the bags is environmentally friendly.

While the invention is described with reference to a coffee product, it is understood that the product may not be so limited. Other hot drinking products, like tea for example, may also be used instead of coffee. What is important is that the product provides the consumer with a pre-mixed, ready to brew drink product that is travel friendly and that does not require any equipment or appliances to brew or make.

The present invention has been described with reference to certain preferred and alternative embodiments that are intended to be exemplary only and not limiting to the full scope of the present invention as set forth in the appended claims.

We claim:

1. A brew bag of drink mix, comprising:
a porous brew bag, and
a drink mix comprising a primary ingredient and an enhancement ingredient.

2. The brew bag of claim 1, wherein said primary ingredient is coffee.

3. The brew bag of claim 1, wherein said primary ingredient is tea.

4. The brew bag of claim 1, wherein said enhancement ingredient is creamer.

5. The brew bag of claim 1, wherein said enhancement ingredient is sugar.

6. The brew bag of claim 1, wherein said enhancement ingredient is an artificial sweetener.

7. The brew bag of claim 1, wherein said enhancement ingredient is honey.

8. The brew bag of claim 1, wherein said enhancement ingredient is vanilla flavoring.

9. The brew bag of claim 1, wherein said enhancement ingredient is caramel flavoring.

10. The brew bag of claim 1, wherein said enhancement ingredient is peppermint flavoring.
